(19) United States
(12) Patent Application Publication
(10) Pub. No.: US 2024/0053236 A1
(43) Pub. Date: Feb. 15, 2024

(54) APPARATUS FOR MULTI-SAMPLE SONICATION AND RELATED METHODS

(71) Applicant: TRIANGLE BIOTECHNOLOGY, INC., Chapel Hill, NC (US)

(72) Inventors: David Allison, Hillsborough, NC (US); Sandeep Kasoji, Durham, NC (US); Joseph McMahon, Chapel Hill, NC (US); Ricky McMahon, Chapel Hill, NC (US)

(21) Appl. No.: 18/257,728

(22) PCT Filed: Dec. 17, 2021
(86) PCT No.: PCT/US2021/064003

§ 371 Date: Jun. 15, 2023

Related U.S. Application Data
(60) Provisional application No. 63/126,852, filed on Dec. 17, 2020.

(51) Int. Cl. G01N 1/40

(52) U.S. Cl. CPC G01N 1/4077; G01N 2001/4094

(57) ABSTRACT

A method of simultaneously sonicating multiple samples consistently with a single acoustic source includes using strategically positioned reflectors, refractors, scatterers, and/or energy distributors (collectively called acoustic energy redirectors).

### RELATED APPLICATIONS

This application claims priority to Application Ser. No. 63/126,852, filed Dec. 17, 2020, the disclosure of which is hereby incorporated by reference in its entireties.

### FIELD OF THE INVENTION

The present invention relates to sonicating microplates for sample processing, and in particular to configurations that increase consistency in simultaneously sonicating samples in microplate wells.

### BACKGROUND

Ultrasound is frequently used for processing, disrupting, and/or homogenizing biological, chemical, and industrial substances. Microplates are frequently used in molecular biology applications, particularly in sample processing (i.e., genomic DNA, chromatin, cells, tissues, etc.) for a range of high-throughput analytical techniques, including next-generation sequencing, chromatin immunoprecipitation, quantitative polymerase chain reaction, and the like. Focused ultrasound may be used for sample processing. However, the current technologies typically can only process one sample at a time, which prolongs processing time and significantly drives up the labor costs. Additionally, since processing occurs serially, a robotic system is used to raster scan the microplate across the single-focus transducer. This also drives up the instrument cost (>$150,000).

When there are multiple samples to process, sonication can be performed serially (one at a time), or the sonication system can be optimized in various ways to sonicate multiple samples simultaneously. When sonicating multiple samples simultaneously, it is desirable to achieve a certain level of uniformity that equates to consistent processing depending on the application. The level of uniformity should match that of serial (one at a time) sonication. There are many types of sonication methods and devices available, many of which can accommodate simultaneous sonication of multiple samples. Types of devices include cuphorn sonicators, microplate horn sonicators, bath sonicators, focused sonicators (a holographic lens can be designed to produce multiple foci), and probe-tip sonicators, which are not designed for multi-sample sonication.

One consideration when sonicating multiple samples simultaneously is the uniformity of the acoustic field of the sonicator. Without a uniform field, techniques such as linear translation or circular rotation are required to ensure each sample receives the same amount of acoustic energy. Another design consideration is the acoustic scattering effect of the sample vessels themselves and how those interactions affect the uniformity of the acoustic field at the target axial depth (position of the sample). For example, consider that a perfectly uniform acoustic field is designed for sonicating a 96-well PCR plate, such that consistent acoustic energy can be measured at the location of each of the wells of the 96-well plate. The reflections, refractions, scattering, and absorption of the ultrasound energy by each of the PCR plate wells (including the contents of each well) may interfere with the incident acoustic wave in a way where all wells do not receive the same magnitude ultrasound energy over a period of active sonication time. This effect can be observed when sonicating a 96-well PCR plate using an effectively uniform acoustic field. When doing so, the corners and edges receive less acoustic energy resulting in less efficient processing in those wells. Even when sonicating a 2D array of samples that is much smaller than the acoustic field, the corners and edges perform less efficiently due to this effect. Therefore, the reduction in acoustic energy around the corners and edges of the well plate appear to be an issue regardless of the size of the plate or the number of sample wells.

### SUMMARY OF EMBODIMENTS OF THE INVENTION

In some embodiments, methods of simultaneously sonicating multiple samples consistently with a single acoustic source includes using strategically positioned reflectors, refractors, scatterers, and/or energy distributors (collectively called acoustic energy redirectors).

In some embodiments, methods of simultaneously sonicating multiple samples consistently with a single acoustic source include using a load on or in the samples to: match the optimum load input of the sonication device; and/or reduce or optimize the energy leakage in the form of vibrations.

In some embodiments, a carrier for holding a plurality of samples in a sonicator includes a base configured to hold the plurality of samples; and one or more acoustic energy redirectors configured to redirect acoustic energy to the plurality of samples.

### BRIEF DESCRIPTION OF THE DRAWINGS

The accompanying drawings, which are incorporated in and constitute a part of the specification, illustrate embodiments of the invention and, together with the description, serve to explain principles of the invention.

FIG. 1A is an illustration of nine cavitation heat maps of a 96-well microplate sonicated with a microplate ultrasonic horn according to some embodiments.

FIG. 1B is a diagram of a top view of a 96-well microplate in which the full perimeter of the microwells is surrounded by one or more acoustic energy redirectors, which results in the cavitation heat map of the first row of FIG. 1A (full perimeter) according to some embodiments.

FIG. 1C is a diagram of a top view of a 96-well microplate in which the corner regions of the microwells are surrounded by one or more acoustic energy redirectors, which results in the cavitation heat map of the second row of FIG. 1A (corners only) according to some embodiments.

FIG. 1D is a diagram of a top view of a 96-well microplate in no acoustic energy redirectors are used, which results in the cavitation heat map of the third row of FIG. 1A (no neighbors).

FIG. 1E is a schematic diagram of an overhead view illustrating the area of the microwell plate and the sonication region according to some embodiments.

FIG. 2 is a perspective view of a sonication system having a sonicator and a fluid bath with a microplate held in the bath by a carrier according to some embodiments.

FIG. 3 is a top view of the sonication system of FIG. 2.

FIG. 4 is a top view of the sonication system of FIG. 2 with a cover positioned on the carrier and microplate.

FIG. 5 is a top perspective view of a carrier of the sonication system of FIG. 2 with a microplate held therein according to some embodiments.

FIG. 6 is a side view of the carrier and microplate of FIG. 5.

FIG. 7 is a bottom perspective view of the carrier and microplate of FIG. 5.

FIG. 8 is a top view of the carrier and microplate of FIG. 5 with a cover positioned on the carrier according to some embodiments.

FIG. 9 is a bottom perspective view of the carrier and microplate of FIG. 5 with a cover positioned on the carrier according to some embodiments.

FIG. 10 is a top perspective view of a carrier and microplate assembly according to some embodiments.

FIG. 11 is a bottom perspective view of the carrier and microplate assembly of FIG. 10.

FIG. 12 is a side view of the carrier and microplate assembly of FIG. 10.

FIG. 13 is a top view of the carrier of FIG. 10.

FIG. 14 is a bottom perspective view of the carrier of FIG. 10.

FIG. 15 is a top perspective view of the carrier of FIG. 10 with a cover positioned on the carrier according to some embodiments.

### DETAILED DESCRIPTION OF EMBODIMENTS OF THE INVENTION

The present invention now will be described hereinafter with reference to the accompanying drawings and examples, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art.

Like numbers refer to like elements throughout. In the figures, the thickness of certain lines, layers, components, elements or features may be exaggerated for clarity.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof. As used herein, the term “and/or” includes any and all combinations of one or more of the associated listed items. As used herein, phrases such as “between X and Y” and “between about X and Y” should be interpreted to include X and Y. As used herein, phrases such as “between about X and Y” mean “between about X and about Y.” As used herein, phrases such as “from about X to Y” mean “from about X to about Y.”

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the specification and relevant art and should not be interpreted in an idealized or overly formal sense unless expressly so defined herein. Well-known functions or constructions may not be described in detail for brevity and/or clarity.

It will be understood that when an element is referred to as being “on,” “attached” to, “connected” to, “coupled” with, “contacting,” etc., another element, it can be directly on, attached to, connected to, coupled with or contacting the other element or intervening elements may also be present. In contrast, when an element is referred to as being, for example, “directly on,” “directly attached” to, “directly connected” to, “directly coupled” with or “directly contacting” another element, there are no intervening elements present. It will also be appreciated by those of skill in the art that references to a structure or feature that is disposed “adjacent” another feature may have portions that overlap or underlie the adjacent feature.

Spatially relative terms, such as “under,” “below,” “lower,” “over,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is inverted, elements described as “under” or “beneath” other elements or features would then be oriented “over” the other elements or features. Thus, the exemplary term “under” can encompass both an orientation of “over” and “under.” The device may be otherwise oriented (rotated 90 degrees or at other orientations) and the spatially relative descriptors used herein interpreted accordingly. Similarly, the terms “upwardly,” “downwardly,” “vertical,” “horizontal” and the like are used herein for the purpose of explanation only unless specifically indicated otherwise.

It will be understood that, although the terms “first,” “second,” etc. may be used herein to describe various elements, these elements should not be limited by these terms. These terms are only used to distinguish one element from another. Thus, a “first” element discussed below could also be termed a “second” element without departing from the teachings of the present invention. The sequence of operations (or steps) is not limited to the order presented in the claims or figures unless specifically indicated otherwise.

The present invention is described below with reference to block diagrams and/or flowchart illustrations of methods, apparatus (systems) and/or computer program products according to embodiments of the invention. It is understood that each block of the block diagrams and/or flowchart illustrations, and combinations of blocks in the block diagrams and/or flowchart illustrations, can be implemented by computer program instructions. These computer program instructions may be provided to a processor of a general purpose computer, special purpose computer, and/or other programmable data processing apparatus to produce a machine, such that the instructions, which execute via the processor of the computer and/or other programmable data processing apparatus, create means for implementing the functions/acts specified in the block diagrams and/or flowchart block or blocks.

A sonicator system for sonicating materials in a sample well of a microplate is provided. In some embodiments, the sonication is useful for shearing biological materials in a sample well of a microplate.

A “microplate” includes any suitable vessels for use with a sonicator that focuses an acoustic field in a specific region, such as an array. Examples of microplates include, but are not limited to, 96- and 384-well PCR plates, and 6-, 12-, 24-, and 96-microtiter plates. It should be understood that other sample arrays may be used, including tubes or vials arranged in an array. Examples of arrays include a grid, linear or circular arrays.

A “rack” or “carrier” or “holder” is used interchangeably herein to refer to a device for holding and positioning samples or holding or positioning vials or a sample well plate.

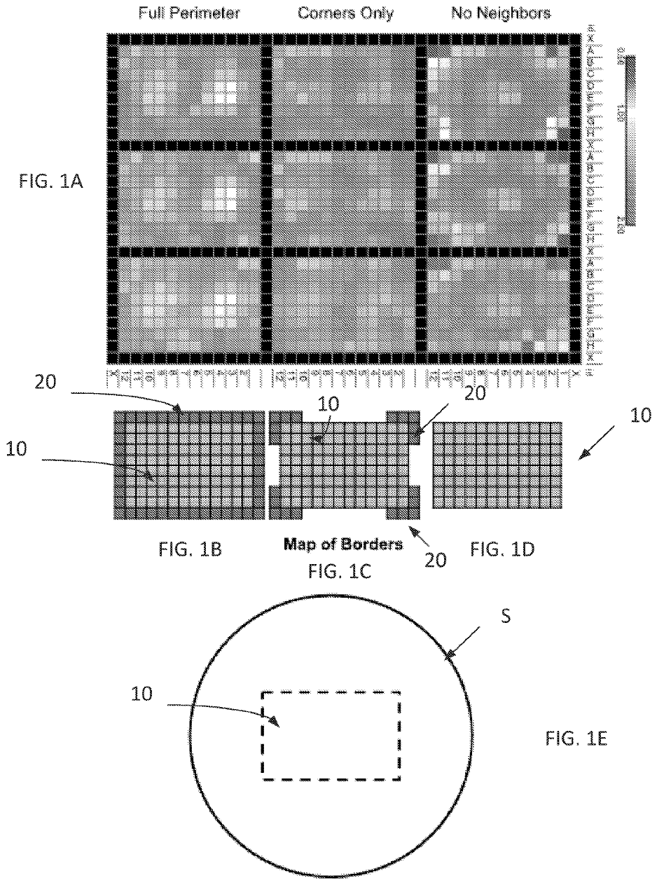

FIG. 1A is an illustration of nine cavitation heat maps of a 96-well microplate sonicated with a microplate ultrasonic horn. FIG. 1B is a diagram of a top view of a 960 well microplate 10 in which the full perimeter of the microwells is surrounded by one or more acoustic energy redirectors 20, which results in the cavitation heat map of the first row of FIG. 1A (full perimeter). FIG. 1C is a diagram of a top view of a 960 well microplate 10 in which the corner regions of the microwells are surrounded by one or more acoustic energy redirectors 20, which results in the cavitation heat map of the second row of FIG. 1A (corners only). FIG. 1D is a diagram of a top view of a 960 well microplate 10 in no acoustic energy redirectors are used, which results in the cavitation heat map of the third row of FIG. 1A (no neighbors). FIG. 1E is a schematic diagram of an overhead view illustrating the area of the microwell plate 10 and the sonication region S of a microplate ultrasonic horn large enough so that the edges of the plate are well within the footprint of the horn. The corners of the of the microwell plate 10 do not efficiently cavitate due to a leakage of acoustic energy when no reflectors are used (FIG. 1D and last row of FIG. 1A). The acoustic energy redirectors 20 are reflectors, which redirect the acoustic energy back to the corners of the microplate 10. The microplate 10 is clearly within the boundaries of the acoustic field or sonication region S yet the corners and edges underperform without additional acoustic energy redirectors 20 positioned nearby to deflect acoustic energy inward.

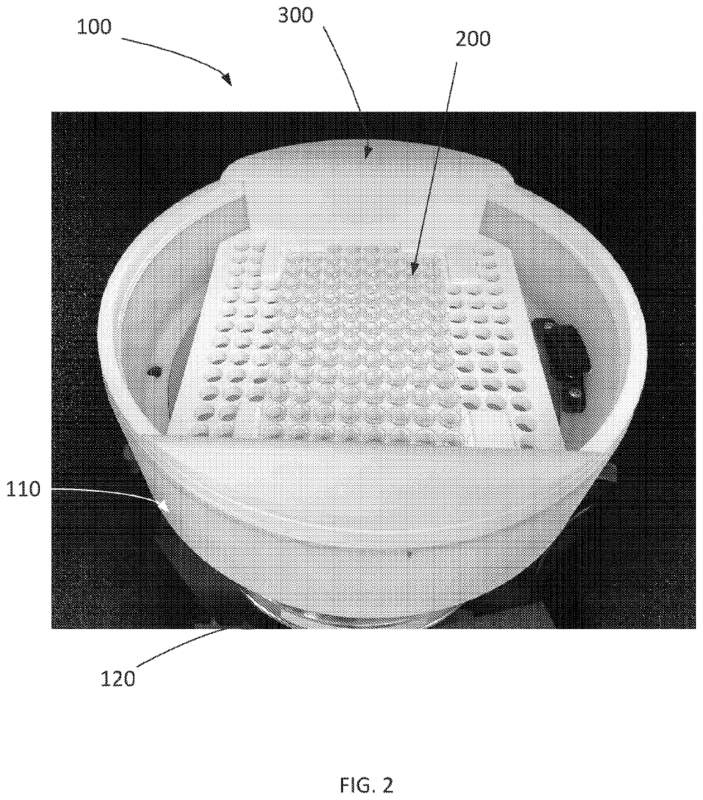

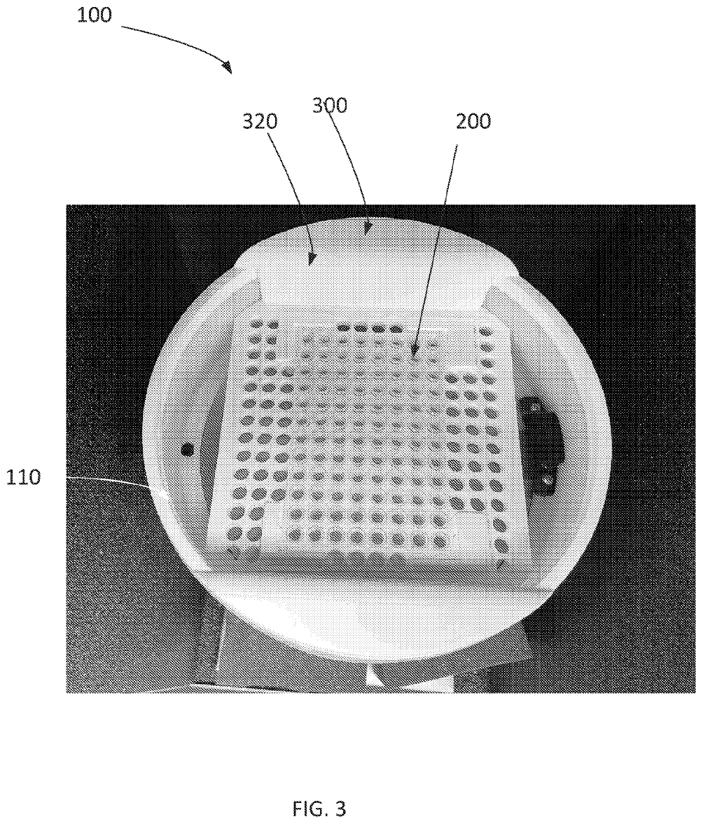

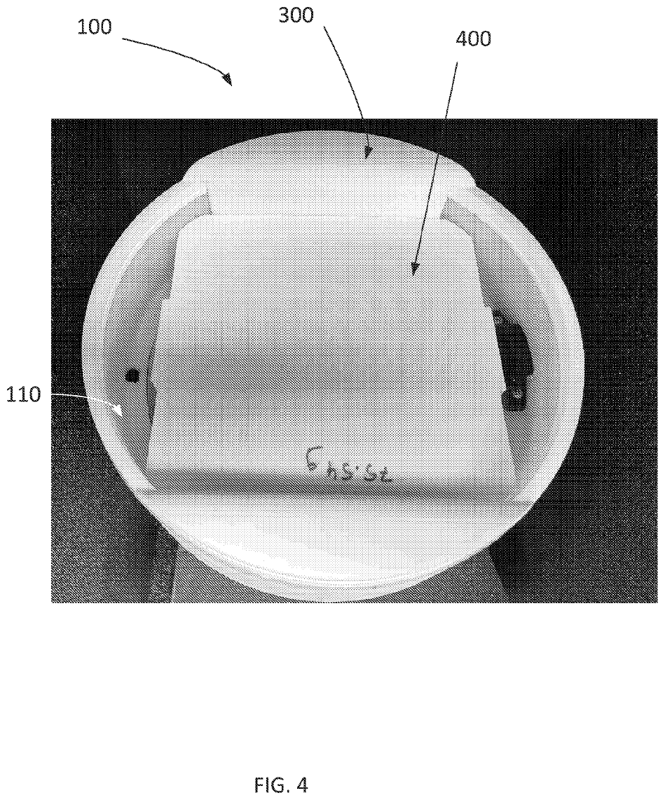

As shown in FIGS. 2 and 3, an ultrasound transducer system 100 includes a bath or container 110 for holding a fluid such as water, and an ultrasound transducer 120. A carrier 300 is positioned in the container 110 and carries a microplate 200 with a plurality of wells 202 for containing samples. The carrier 300 is held in the container 110 with handles 320, which hold the carrier 300 and the microplate 200 so that the microplate 200 is partially submerged in the fluid in the container 110. As shown in FIG. 4, a cover 400 is positioned on microplate 200.

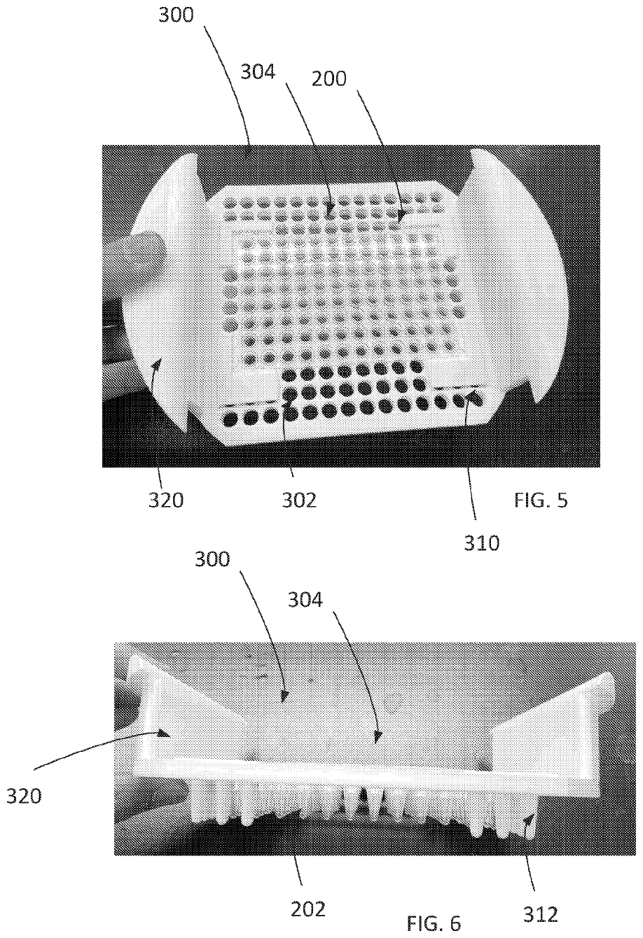

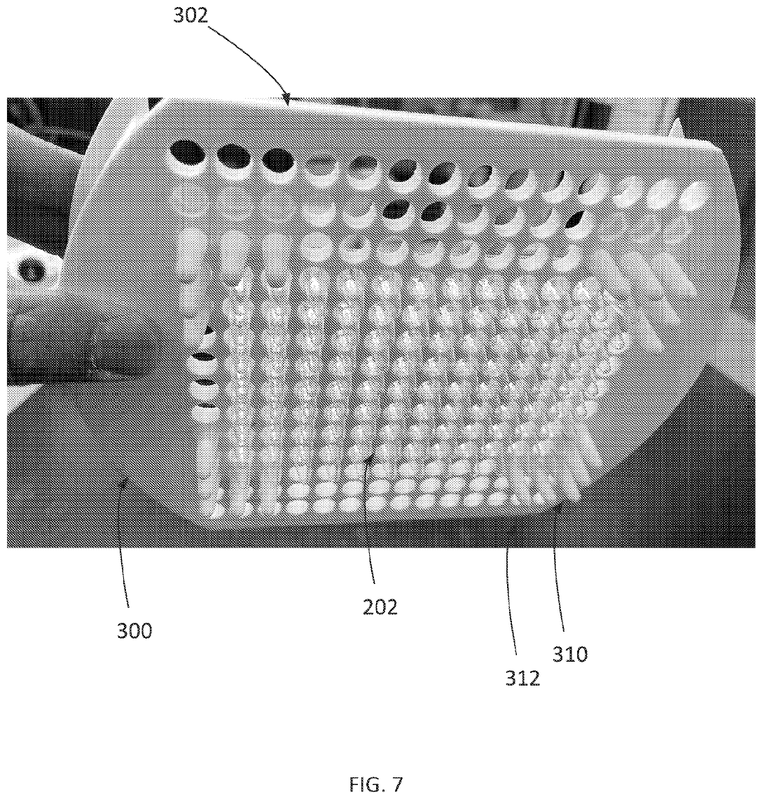

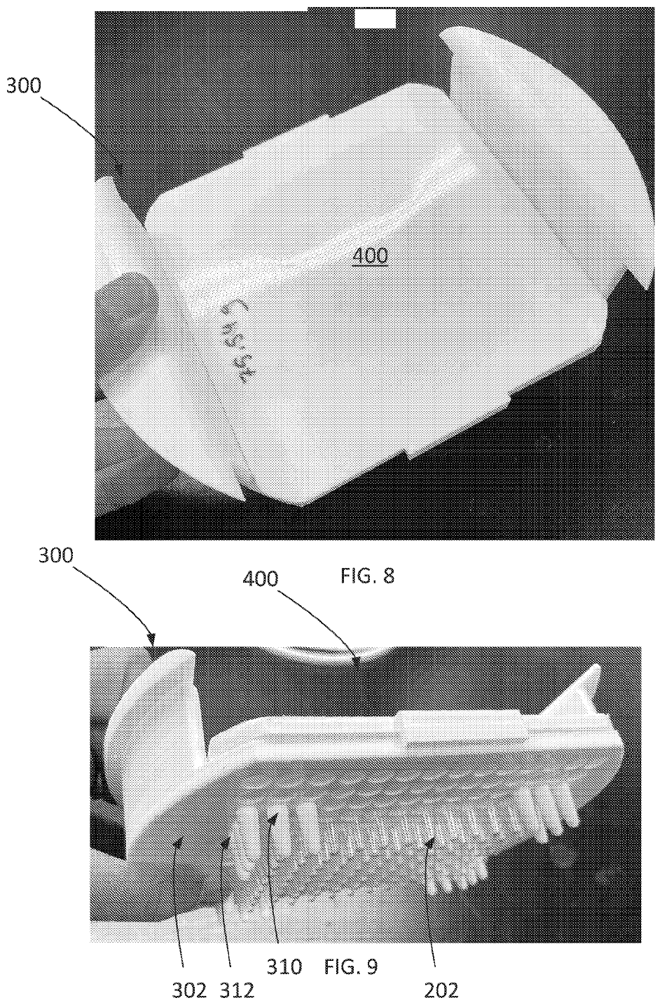

As illustrated in FIGS. 5-9, the carrier 300 includes a base 302 with apertures 304. The microplate 200 fits on top of the base 302 with the wells 202 extending through the apertures 304 of the carrier 300.

The carrier 300 includes acoustic energy redirectors, such as reflectors 310 to redirect acoustic energy to more evenly distribute the acoustic energy across the wells 202 of the microplate 200. As illustrated in FIGS. 6-7 and 9, the reflectors 310 have extending member 312 extend away from the side of the base 302 and approximate the size, shape and position of the wells 202. For example, the reflectors 310 have extending member 312 with a tapered shape that is similar to the shape of the well 202. As illustrated, the reflectors 310 are formed of materials, such as a rigid, elastomeric material (plastic) or metal, that reflects acoustic energy and/or mimics additional wells. However, other shapes may be used, including cylinders, rods, or flat surfaces, such as a wall. In addition, the reflectors 310 are illustrated as separate members that extend along a partial perimeter of the array of wells 202. In particular, the reflectors 310 are positioned at and around the corners of the array of wells 202; however, in some embodiments, the reflectors 310 may extend the full perimeter of the array of wells 202 either continuously or intermittently, or other portions or regions of the carrier 300 may include reflectors 310 or other acoustic energy redirectors.

The objects used as reflectors or acoustic energy redirectors can be solid or hollow, and be composed of metal, plastic, polymers, glass, rubber, silicone, ceramics, crystals, or other appropriate material depending on the mode of operation, including titanium and stainless steel or TPX (Polymethylpentene) plastic. The acoustic energy redirectors may be designed with a consistent or non-replicating internal structural pattern. For example, a non-reflective material may be used to refract ultrasound waves for one application, whereas a highly reflective material (i.e. glass or metal) might be used for another application. The shape of the objects is dependent on the mode of interaction with the acoustic field. For example, for scattering, the object might be smaller than the wavelength of the incident wave. For reflections, the object might be larger than the wavelength of the incident wave and be a flat, angled surface to redirect the energy to a specific location. The arrangement of the objects depends on the sonication device (dimensions of the transducer or horn), the arrangement of samples in the sonicator and other processing factors.

In this configuration and without intending to be bound by any particular theory, the reflectors 310 redirect acoustic energy so that the reduction or leakage in sonication that has been observed (see FIG. 1A), e.g., at the corner regions of the array of wells 202 may be reduced. Therefore, the corner areas of the array may receive a total acoustic energy distribution, including direct acoustic energy and redirected acoustic energy, that approximates the acoustic energy in the interior region of the microplate 200. In some embodiments, the reflectors 310 may be formed of the same material as the carrier 300, or a different material may be used.

In some embodiments, an optional load, such as the cover 400, may be used to distribute a load or weight on the carrier 300. Although the cover 400 is illustrated as a flat cover over the carrier 300 and microplate 200, it should be understood that other weighted or load configurations may be used. Without wishing to be bound by any particular theory, the load or cover 400 may dampen vibrations of the carrier 300 and/or microplate 200, which may lead to more even distribution of acoustic energy. The weight of the cover or load may be from 50 g to 250 g, or 100 g to 200 g.

In some embodiments, methods may be used to simultaneously sonicate multiple samples consistently with a single acoustic source using a load (such as the cover 400) on or in the samples to match the optimum load input of the sonication device and/or reduce or optimize the energy leakage in the form of vibrations. The load may be partially or wholly submerged in the sonication device bath or the load may be above the sonication device bath. In some embodiments, the load is configured as a cover that at least partially covers the samples and may be in the form of a weighted object on the samples. The load may be distributed across all the samples or may be distributed across a portion of the samples. The load may be distributed across the center portion of the samples, the outer portion of the samples, across a band of samples in the middle, or across alternating samples, in any multiple or in a pattern. The load may be a lid, integrated with a sample carrier or rack, that provides a clamping force on the vessels.

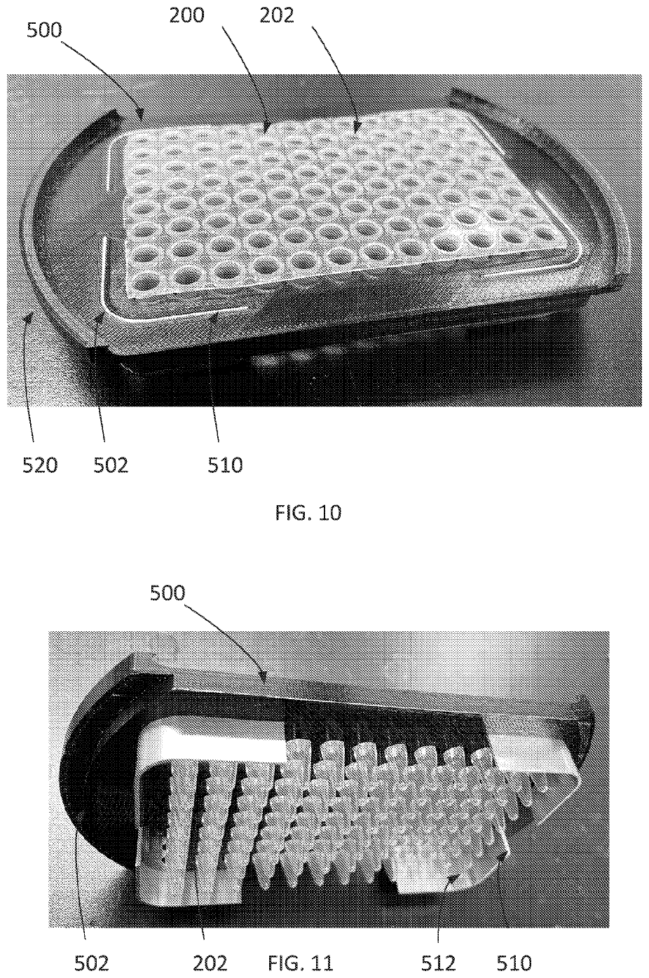

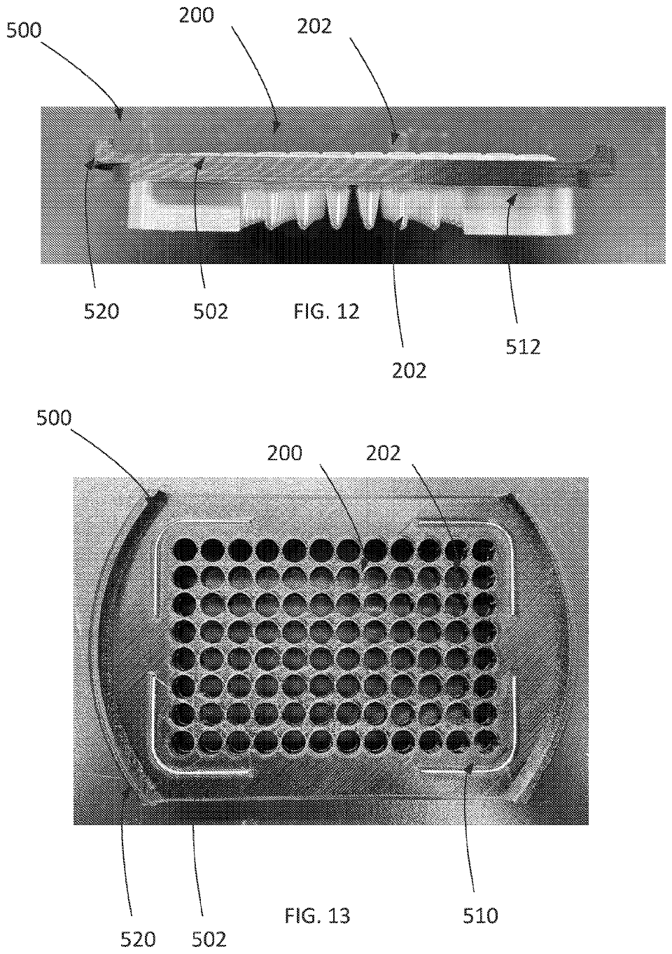

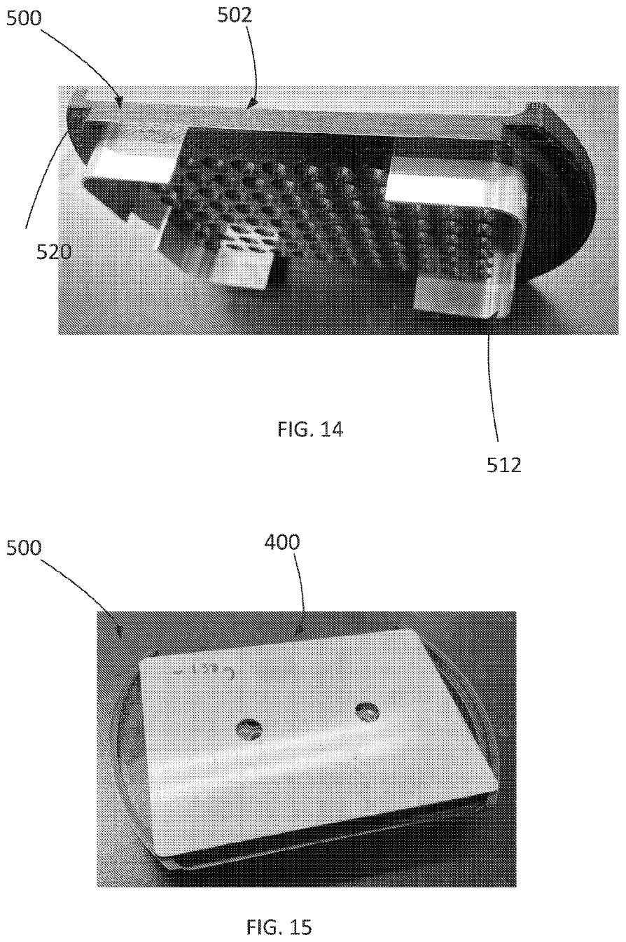

As illustrated in FIGS. 2-9, the reflectors 312 generally mimic the size and shape of the sample wells 202. However, it should be understood that other shapes and configurations may be used, such as shown in FIGS. 10-15. As illustrated, a carrier 500 has a base 502 with apertures 504 configured to receive a microplate 200. A handle 520 is configured to rest on a side of an ultrasound bath to hold the carrier 500 in the water, such as is shown in FIGS. 2-4. The carrier 500 includes acoustic energy redirectors or reflectors 510 that include a wall or extending member 512. As shown, the wall reflector 510 extends below the bottom side of the carrier 500 and extend around the corners of the array of apertures 504 where the microplate 200 and wells 202 are positioned. The extending member 512 may be a generally planar or flat wall that is curved around the edges of the array of sample wells 202; however, the extending member 512 may have angled or sharp edges (e.g., at a 90 degree or other angle). The extending member 512 may extend around the edges of the array of sample wells 202 as illustrated, or the reflector 512 may extend around the entire perimeter or a portion of the perimeter of the array of sample wells 202. Moreover, smaller or larger flat reflectors may be positioned around the array as desired for a particular application.

As illustrated, the carrier 500 is formed of a rigid polymeric material, and the reflectors 510 are formed of metal. However, other materials, such as glass or polymer materials, may be used and/or the reflectors 510 may be formed from the same material as the carrier 500, and in some embodiments, may be a single, integrated piece.

The samples may be biological samples, chemical samples or combinations thereof. The lens may be configured to focus the acoustic energy so as to shear nucleic acids, proteins, chromatin and/or intracellular materials. The lens may be configured to focus the acoustic energy for the lysis of cells, tissue, and/or biofilm for the extraction or release of intracellular or extracellular materials such as proteins, metabolites, nucleic acids and chromatin. The lens may be configured to focus the acoustic energy for in-vitro sonoporation of cells and tissues for the purposes of transfection, drug delivery, or applications requiring a transient permeability of cellular or tissue membrane. Biological samples include, but are not limited to, source organisms of cells, tissues or biofilms of samples, and eukaryotic (vertebrate, invertebrate, and plant samples), microbial, and viral samples. In some embodiments, sonication systems may be used to create emulsions. Applications include, but are not limited to, high throughput extraction of materials for pathogen diagnostics, as well as the extraction of metabolites from plant specimens for drug analysis.

Embodiments of the current invention may be used for in-vitro or in-vivo sonoporation. Organic or non-organic materials may be used as samples in the sample wells.

In some embodiments, the samples may be inorganic or non-biologic in nature.

The acoustic source may be a bath sonicator, cup horn sonicator, focused sonicator, or other induced or natural force field. The frequency of the acoustic source may range from 1 kHz to 100 MHz. The ultrasound frequencies generally applied by the transducer, in some embodiments, may be 10 kHz-2 MHz, 2 MHz-10 MHz, or 10 MHz-50 MHz.

As illustrated, the samples are arranged in a rectangular array; however, a rectangular or circular pattern may be used, and other geometries (2D or 3D) may be used for various biological, chemical, or industrial applications.

The acoustic energy redirectors and/or the carrier may be 3D printed, injection molded, blow-molded, extruded, cast, or machined. The acoustic energy redirectors may be arranged proximally to the samples or distally to the samples, so that the acoustic field energy specific to the sonication device is redirected towards the samples. The acoustic energy redirectors can be arranged outside of a perimeter of a sample array or between samples in a sample array, such that the acoustic field energy specific to the sonication device is redirected towards the samples.

In some embodiments, modeling systems may be used to determine a position, shape, and/or composition of the acoustic energy redirectors. For example, the configuration of the acoustic energy redirectors may be computationally determined through finite element analysis.

In some embodiments, the acoustic energy redirectors affect the load on the sonication devices so that the device transduces energy more closely to design requirements and is more effective and efficient in its energy transmission to the array of wells.

Although embodiments according to the present invention are illustrated with respect to acoustic energy redirectors that are provided as part of the carrier or rack that holds the microplate in the sonicator device, the acoustic energy redirectors may be provided as separate pieces or integrated or mounted on other elements of the sonication system. For example, the acoustic energy redirectors may be attached to the ultrasound bath container 110 or other elements of the sonication system. Moreover, although the carrier is illustrated as holding a microplate sample array, the carrier may be configured to hold individual sample tubes, strips of tubes, 2D arrays of tubes, microplates, PCR plates, automation compatible plates, and skirted, semi-skirted, and unskirted plates. The sample wells may be provided as integrated on a plate or by separate tubes, and the carrier may hold plastic tubes, metal tubes, and glass tubes. The carrier may include a handle or other region that is designed for the end effector of a liquid handling robot or other type of automation system.

Although any suitable sample or sample well configuration may be used, some embodiments may be optimized for 24-96 samples or for 96-384, or 1536 samples. In some embodiments, the number of samples can ranges from 1-10,000.

The foregoing is illustrative of the present invention and is not to be construed as limiting thereof. Although a few example embodiments of this invention have been described, those skilled in the art will readily appreciate that many modifications are possible in the exemplary embodiments without materially departing from the novel teachings and advantages of this invention. Accordingly, all such modifications are intended to be included within the scope of this invention as defined in the claims. Therefore, it is to be understood that the foregoing is illustrative of the present invention and is not to be construed as limited to the specific embodiments disclosed, and that modifications to the disclosed embodiments, as well as other embodiments, are intended to be included within the scope of the appended claims. The invention is defined by the following claims, with equivalents of the claims to be included therein.

1. A method of simultaneously sonicating multiple samples consistently with a single acoustic source using strategically positioned acoustic energy redirectors comprising reflectors, refractors, scatterers, and/or energy distributors.

2. The method of claim 1, wherein the samples are biological in nature.

3. The method of claim 1, wherein the samples are inorganic, or non-biological in nature.

4. The method of claim 1, wherein the acoustic source is a bath sonicator, cup horn sonicator, focused sonicator, or other induced or natural force field.

5. The method of claim 1, wherein the frequency of the acoustic source ranges from 1 kHz to 100 MHz.

6. The method of claim 1, wherein the samples are arranged in a rectangular or circular pattern, or other two-dimensional or three-dimensional geometries (2D or 3D) that may be relevant for biological, chemical, or industrial applications.

7. The method of claim 1, wherein the samples are loaded in a 96, 384, 1536, or other SBS-standard or non-standard microplate/PCR plate

8. (canceled)

9. The method of claim 1, wherein the acoustic energy redirectors are solid, hollow, semi-hollow, or designed with a consistent or non-replicating internal structural pattern in terms of composition.

10. The method of claim 1, wherein the acoustic energy redirectors are composed of metal, plastic, glass, any type of polymer, rubber, silicone, ceramics, or crystals.

11. The method of claim 1, wherein the acoustic energy redirectors are discrete objects or a continuous singular object.

12. The method of claim 1, wherein the acoustic energy redirectors are 3D printed, injection molded, blow-molded, extruded, cast, or machined.

13. The method of claim 1, wherein the acoustic energy redirectors are arranged outside of a perimeter of a sample array or between samples in a sample array, such that the acoustic field energy specific to the sonication device is redirected towards the samples.

14. The method of claim 1, wherein the acoustic energy directors are arranged in a pattern determined computationally through finite element analysis.

15. The method of claim 1, wherein the acoustic energy redirectors affect the load on the sonication devices such that the device transduces energy more closely to design requirements and therefore more effectively and efficiently.

16. The method of claim 1, wherein the acoustic energy redirectors are integrated into a rack designed to hold and position the samples.

17. The method of claim 16, wherein the rack is configured to hold individual sample tubes, strips of tubes, 2D arrays of tubes, microplates, PCR plates, automation compatible plates, and skirted, semi-skirted and unskirted plates.

18. The method of claim 16, wherein the rack has regions designed for the end effector of a liquid handling robot or any other type of automation system.

19. The method of claim 16, wherein the rack is configured to hold plastic tubes, metal tubes, and glass tubes.

20. An acoustic energy redirector or rack for use in the method of claim 1.

21. A method of simultaneously sonicating multiple samples consistently with a single acoustic source using a load on or in the samples to:
a. match the optimum load input of the sonication device; and/or
b. reduce or optimize the energy leakage in the form of vibrations.

22.-23. (canceled)

24. The method of claim 21, wherein the acoustic source is a bath sonicator, cup horn sonicator, or focused sonicator.

25.-28. (canceled)

29. The method of claim 21, wherein the load is an object that is partially or wholly submerged in the sonication device bath, such that the total load on the device is affected.

30. The method of claim 21, wherein the load is a weighted object that is placed on top of the samples.

31. The method of claim 30, wherein the load is distributed across a portion of or all of the samples.

32. (canceled)

33. The method of claim 31, wherein the load is distributed across the center portion of the samples, the outer portion of the samples, across a band of samples in the middle, or across alternating samples in any multiple or pattern.

34. The method of claim 21, wherein the load is a lid, integrated with a sample rack that provides a clamping force on the vessels.

35.-37. (canceled)

38. A load or carrier for use in the method of claim 21.

39. A carrier for holding a plurality of samples in a sonicator, the carrier comprising:
a base configured to hold the plurality of samples; and
one or more acoustic energy redirectors configured to redirect acoustic energy to the plurality of samples.

40. The carrier of claim 39, wherein the acoustic energy redirectors extend away from the base.

41. The carrier of claim 39, wherein the base is configured to receive a microplate having a plurality of wells with the plurality of samples therein.

42. The carrier of claim 39, wherein the base comprises a generally planar portion having apertures therein the receive the plurality of wells.

43. The carrier of claim 39, wherein the plurality of wells extend away from a side of the generally planar portion of the base.

44. The carrier of claim 39, wherein the one or more acoustic energy redirectors extend away from the side of the generally planar portion of the base.

45. The carrier of claim 39, wherein the one or more acoustic energy redirectors are formed of a material that redirects acoustic energy impinged on the material.

46. The carrier of claim 45, wherein the material comprises an elastomeric material or metal.

47. The carrier of claim 39, wherein the one or more acoustic energy redirectors are positioned adjacent an edge or a corner of the carrier.

48. The carrier of claim 39, wherein the carrier comprises an interior region and an edge portion, and the carrier is configured to hold the plurality of samples at an interior region, and the one or more acoustic energy redirectors are positioned in the edge portion.

49. The carrier of claim 39, wherein the one or more acoustic energy redirectors are well- or cylindrically-shaped.

50. The carrier of claim 39, wherein the one or more acoustic energy redirectors comprises a wall that extends away from the base.

51. The carrier of claim 39, wherein the one or more acoustic energy redirectors comprise reflectors.

52. The carrier of claim 39, further comprising a load on the base that is configured to distribute a load on the microplate, the load being configured to reduce vibrations of the samples during sonication.

53. The carrier of claim 39, wherein the load comprises a removeable cover.
